(19) United States
(12) Patent Application Publication
(10) Pub. No.: US 2003/0052970 A1
(43) Pub. Date: Mar. 20, 2003

(54) Automatically activated wireless microphone for in-car video system

(76) Inventors: G. Alfred Dodds, Laguna Niguel, CA (US); James K. Creviston, Chanute, KS (US)

Correspondence Address: Janes J. Kernell, Chase Law Firm, L.C., Suite 130, 4400 College Boulevard, Overland Park, KS, 66211, US

(21) Appl. No.: 10/247,729

(22) Filed: Sep. 19, 2002

Related U.S. Application Data
(60) Provisional application No. 60/323,478, filed on Sep. 19, 2001.

(51) Int. Cl. H04N 7/18; H04N 9/47; B60Q 1/00; B60C 23/00; G08G 1/017; G08G 1/054

(52) U.S. Cl. 348/148; 340/425.5; 340/436; 340/446; 340/447; 340/937

(57) ABSTRACT

A wireless microphone system for a vehicle mounted surveillance system including an audio/video recorder, which may be automatically activated. Upon activation by the surveillance system, an ultrasonic transmitter generates an ultrasonic signal which is received by a portable wireless microphone to activate a radio transmitter. The radio transmitter generates a radio signal including audio information which is received by the surveillance system and recorded.

This application claims the benefit of a prior filed, co-pending application Serial No. 60/323,478 filed Sep. 19, 2001, entitled AUTOMATICALLY ACTIVATED WIRELESS MIC FOR IN-CAR VIDEO SYSTEM.

### BACKGROUND OF THE INVENTION

This invention relates to the automatic activation of microphones for surveillance systems and, more particularly, to an automatically activated wireless microphone for use with a vehicle mounted surveillance system including a video camera and recorder used by law enforcement personnel to record traffic stops and crime scenes.

In law enforcement, there are many commercially available vehicle mounted audio and video surveillance systems which provide an audio and video record of a traffic stop. An example of such systems is set forth in U.S. Pat. Nos. 4,789,904 and 4,949,186. These surveillance systems provide an audio and video record which may be used for investigation and trial of an offender, and oftentimes eliminate any doubt as to the occurrences at a traffic stop or a crime scene. Typically a video camera and recorder are mounted in the vehicle and a clip-on wireless microphone is worn by the police officer for the purpose of transmitting audio signals to the recorder when the officer leaves the vehicle.

One problem with these systems is that the officer may forget to turn on the microphone. If this occurs, no audio is recorded for the stop, which may make the video recording useless as a record of the event or arrest.

### SUMMARY OF THE INVENTION

It is, therefore, a primary object of the present invention to provide a wireless microphone in combination with a vehicle mounted surveillance system, wherein the microphone is automatically activated when the surveillance system begins recording.

Another important object of the present invention is to provide a wireless microphone in combination with a vehicle mounted surveillance system as aforesaid, wherein the microphone is automatically activated inside the vehicle before the officer leaves the patrol car to investigate or issue a citation.

Yet another important object of the present invention is to provide a wireless microphone in combination with a vehicle mounted surveillance system as aforesaid, wherein the microphone is automatically activated when the emergency lights or siren of the patrol vehicle are turned on.

Still another important object of the present invention is to provide a wireless microphone in combination with a vehicle mounted surveillance system, wherein an activation signal at ultrasonic frequencies is automatically transmitted within the patrol car to initiate operation of the microphone when the surveillance system is activated, thereby assuring that an audio recording will be made.

Yet another important object of the present invention is to provide such a transmitted activation signal at a frequency which precludes interference with other electronic equipment within the patrol vehicle.

These and other objects of the invention are achieved by incorporating an ultrasonic detector into the wireless microphone circuitry to control activation of the transmitter, which typically transmits at VHF frequencies. An ultrasonic transmitter is interfaced with the surveillance system, and activated along with the emergency lights or when the surveillance system begins recording. The ultrasonic detector decodes the signal received from the ultrasonic transmitter and enables the VHF transmitter of the wireless microphone circuit.

Other objects and advantages of this invention will become apparent from the following description taken in connection with the accompanying drawings, wherein is set forth by way of illustration and example, a preferred embodiment of the present invention.

### BRIEF DESCRIPTION OF THE DRAWINGS

FIG. 1 is a diagrammatic illustration of the system of the present invention.

FIG. 2 is a functional block diagram of the ultrasonic generator circuit.

FIG. 3 is a functional block diagram of the VHF transmitter and ultrasonic decoder circuit.

### DESCRIPTION OF THE PREFERRED EMBODIMENT

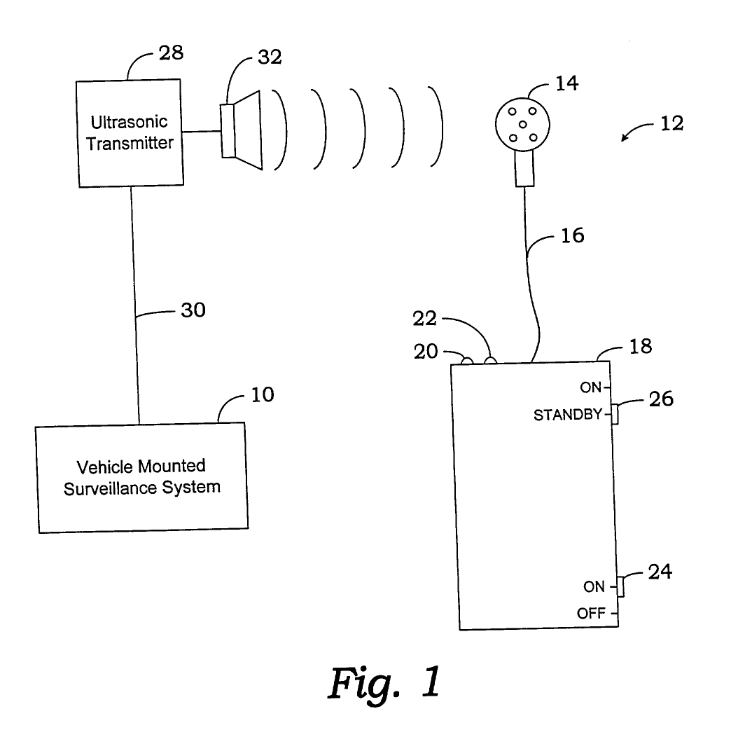

Turning more particularly to the drawings, FIG. 1 illustrates the primary components of the present invention. A vehicular video surveillance system 10 includes a video camera, audio and video recorder, monitor and control center which allows an audio and video recording to be made of traffic stops, chases, and field sobriety tests, for example. One such system 10 for law enforcement applications is the Eyewitness® in-car video system available from Kustom Signals, Inc. of Lenexa, Kans., USA. The video camera is typically mounted to the windshield near the rearview mirror in a patrol vehicle. The monitor and control center are mounted within easy reach of the driver's seat in the patrol vehicle such as in a center console above the rearview mirror adjacent the headliner. The audio and video recorder (VCR) is secured in a vault mounted in the trunk of the vehicle.

A wireless microphone 12 is worn by the police officer to allow audio recording of events outside the patrol vehicle. Wireless microphone 12 includes a clip-on microphone 14, a mic cord 16, and a VHF transmitter and ultrasonic decoder 18. The mic cord 16 also acts as an antenna for transmitter 18. A green LED 20 on the transmitter 18 is illuminated when the transmitter 18 is on. When the battery voltage drops below a predetermined level, a red LED 22 illuminates to alert the police officer that the battery is low and the audio signal may not be received from the transmitter 18. Transmitter 18 also includes a power switch 24 and a STANDBY/ON switch 26.

Power switch 24 controls power to STANDBY/ON switch 26 which controls power to transmitter 18. Typically, at the beginning of a shift, the police officer moves switch 24 to the “ON” position. At the end of the shift the officer turns the transmitter 18 off by moving switch 24 to the “OFF” position. When switch 26 is in the “STANDBY” position, transmitter 18 is automatically activated when an ultrasonic signal is received by microphone 14 from the transducer 32 of an ultrasonic transmitter 28. In the “ON” position, switch 26 supplies power from switch 24 to transmitter 18.

Ultrasonic transmitter 28 is connected to the recorder of system 10 via control line 30. The ultrasonic transducer 32 emits an approximately 20 kHz ultrasonic signal. Transmitter 28 and transducer 32 may be mounted on or adjacent the control center in the patrol vehicle.

In operation, when the emergency lights on a patrol vehicle are activated, video system 10 is automatically activated as is customary in systems of this type. This activates ultrasonic transmitter 28 which drives transducer 32 to saturate the interior of the patrol vehicle with an encoded ultrasonic signal. Microphone 14, clipped to the officer's uniform, picks up the encoded ultrasonic signal which is decoded by the transmitter and ultrasonic decoder 18 to activate the VHF transmitter automatically. Any time the surveillance system 10 is activated, whether automatically or manually, ultrasonic transmitter 28 is enabled to transmit the encoded ultrasonic signal to wireless microphone 12 and automatically activate transmitter 18.

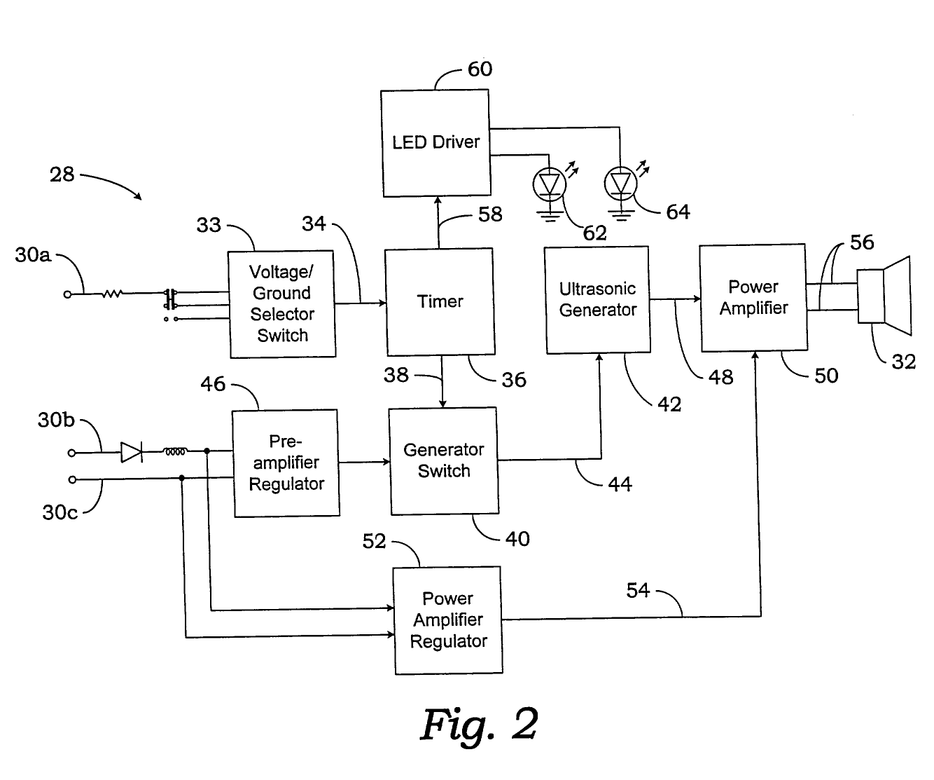

Referring to FIG. 2, a functional block diagram of the ultrasonic transmitter 28 is shown. Ultrasonic transmitter 28 operates from the vehicle's electrical system which is typically approximately 13.8 VDC using a 12 VDC battery input on line 30b with line 30c connected to vehicle ground. An input signal on control line 30a activates ultrasonic transmitter 28, which may be activated by a voltage or a ground signal. A voltage condition is considered for voltages above approximately 8 volts, and a ground condition is considered for voltages below approximately 3 volts. Voltage/ground selection switch 33 is set to the desired activation signal. When an activation voltage is detected on control line 30a by voltage/ground selection switch 33, an output signal on line 34 triggers a timer 36. In response, timer 36 outputs a signal on line 38 to close generator switch 40 and thereby enable ultrasonic generator 42 by connecting it to a regulated power supply 46 via line 44. Ultrasonic generator 42 outputs a signal on line 48 to power amplifier 50 which receives regulated power from power amplifier regulator 52 on line 54. Power amplifier 50 has an output of approximately 1-3 watts to drive transducer 32 via lines 56 to output the ultrasonic signal.

Timer 36 also outputs a control signal on line 58 to LED driver 60 which drives green LED 62 and red LED 64. LED driver 60 energizes green LED 62 when ultrasonic transmitter 28 is powered on and is waiting for a signal command on line 58 from timer 36 to start transmitting. LED driver 60 energizes red LED 64 when it receives a signal on line 58 from timer 36 indicating that an ultrasonic signal is being transmitted. Timer 36 may be active for 5 to 10 seconds and may repeat the ultrasonic transmission two or more times to ensure activation of wireless microphone 12. After completing its activation cycle, timer 36 resets and waits for the next activation voltage on line 30a.

Ultrasonic generator 42 operates approximately between 18-35 kHz and may operate at frequencies as high as 50 kHz. However, components for both transmitter 28 and wireless microphone 12 may be cost prohibitive at higher frequency ranges and may also cause and be more susceptible to RFI. Ultrasonic transducer 32 transmits a high amplitude ultrasonic signal that remains within the patrol vehicle to take advantage of bounce paths and effectively saturate the interior of the vehicle to ensure activation of the wireless microphone 12.

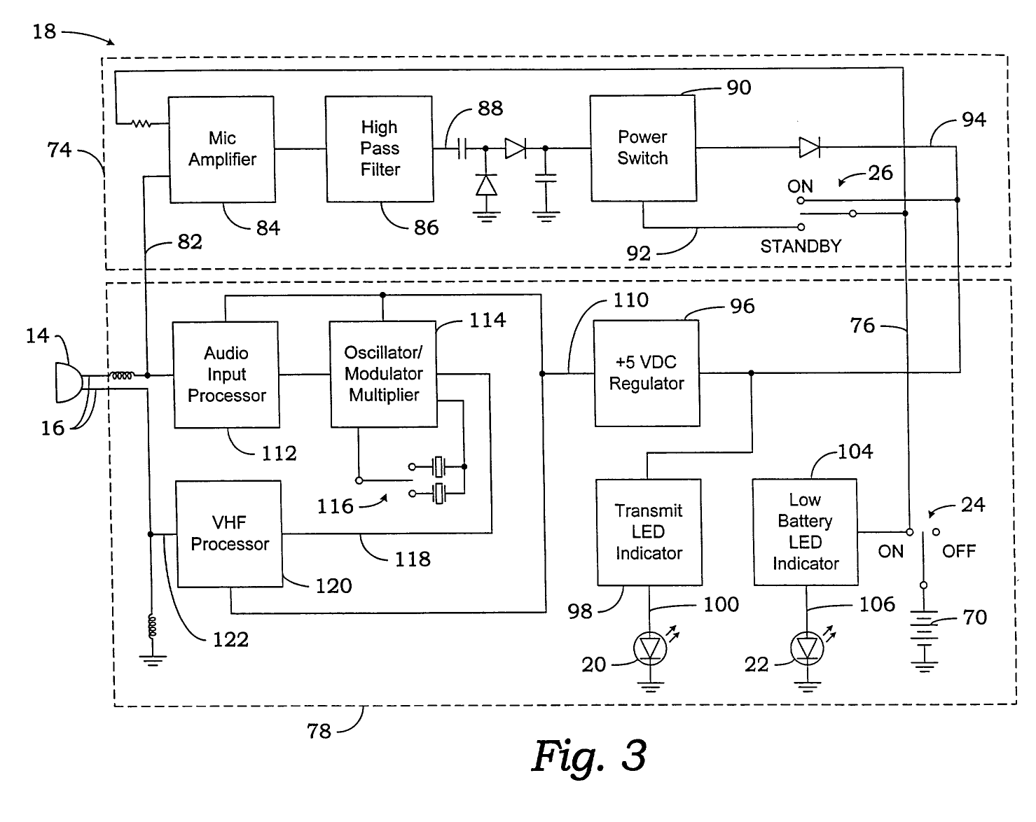

Referring to FIG. 3, a functional block diagram of the VHF transmitter and ultrasonic decoder 18 is shown and is powered by a 9 VDC battery 70. Power switch 24 controls power to an ultrasonic decoder circuit 74 on line 76 which controls power to the VHF transmitter circuit 78. STANDBY/ON switch 26 provides selective control of power to VHF transmitter circuit 78. In the ON position, power is always supplied to VHF transmitter circuit 78 bypassing ultrasonic decoder circuit 74.

When switch 26 is in the STANDBY position, power is supplied to VHF transmitter circuit 78 when an ultrasonic signal is received by microphone 14 which is output on line 82 to microphone amplifier 84. The signal is amplified and fed to high pass filter 86. If the ultrasonic signal is of the correct frequency, it is passed to output line 88 from high pass filter 86. The signal is rectified and triggers the power switch 90 to pass the 9 VDC power through switch 26 on line 92 to line 94. Five-volt regulator 96 converts the 9 VDC input on line 94 to provide regulated 5 VDC power to the electronic components of VHF transmitter circuit 78. When VHF transmitter circuit 78 is enabled, transmitter LED indicator 98 is activated and outputs a voltage on line 100 to illuminate green transmit LED 20. If the voltage level of battery 70 falls below a predetermined level, battery low indicator 104 outputs a voltage on line 106 to illuminate red battery low LED 22.

Five-volt DC regulator 96 provides power on line 110 to a microphone audio input processor 112 which amplifies, compresses and encodes the input voice signal and may use a continuous tone coded squelch system (CTCSS). The CTCSS encodes a sub-audible tone on the modulated signal which is decoded by the receiver in the surveillance system 10 to open squelch and record the transmission. The CTCSS enables the surveillance system 10 to distinguish different transmissions on the same carrier frequency. The audio signal is applied to a VHF carrier signal by oscillator-modulator multiplier 114 the frequency of which is selectable by frequency selection switch 116. Frequency selection switch 116 must be set to the same frequency of the audio receiver of the video surveillance system in order to be received and recorded. The output on line 118 is conditioned by VHF processor 120 which includes a multiplier, RF amplifier and low pass filter. The VHF signal is output on line 122 which is transmitted to the surveillance system using microphone cord 16 as an antenna.

In operation, the officer turns on the VHF transmitter 18 by moving switch 24 to the ON position when starting his or her shift. Switch 26 is moved to the STANDBY position. When switch 26 is in the STANDBY position, and VHF transmitter 18 has been activated, it continually transmits signals from wireless microphone 12 to the surveillance system in the patrol vehicle. To turn off the transmitter 18, the officer moves switch 24 to the OFF position and then back to the ON position which resets power switch 90 and the ultrasonic detector circuit 74. The transmitter 18 is thereby reset and will respond to a subsequent ultrasonic activation. When the officer's shift is finished, he or she turns VHF transmitter power switch 24 to the OFF position.

Having thus described the invention, what is claimed as new and desired to be secured by Letters Patent is as follows:

1. A wireless microphone system for use with a surveillance system for a law enforcement vehicle, wherein said surveillance system includes a video camera and an audio/video recorder, said wireless microphone system comprising:
an ultrasonic transmitter for generating an ultrasonic signal in response to receiving an activation signal from said surveillance system,
a portable wireless microphone adapted to be worn by an operator of said law enforcement vehicle and having an ultrasonic receiver, a microphone component and a radio transmitter, said ultrasonic receiver responsive to an ultrasonic signal received from said ultrasonic transmitter to activate said radio transmitter,
said radio transmitter generating a radio signal in response to audio communications received by said microphone component, and
a radio receiver responsive to said radio signal for generating audio signals to be recorded by said audio/video recorder.

2. The wireless microphone system as claimed in claim 1 wherein said microphone component receives said ultrasonic signal.

3. The wireless microphone system as claimed in claim 1 wherein said ultrasonic signal is encoded by said ultrasonic transmitter and decoded by said ultrasonic receiver.

4. The wireless microphone system as claimed in claim 1 wherein said ultrasonic transmitter generates said ultrasonic signal for a predetermined period of time.

5. The wireless microphone system as claimed in claim 4 wherein said ultrasonic transmitter repeats said generation of said ultrasonic signal a predetermined number of times.

6. The wireless microphone system as claimed in claim 1 wherein said radio signal is encoded by said radio transmitter and decoded by said radio receiver.

7. The wireless microphone system as claimed in claim 1 further comprising a reset switch to deactivate said radio transmitter.

8. In combination with a surveillance system for a law enforcement vehicle, a wireless microphone system comprising:
a video camera mounted in said law enforcement vehicle for generating video signals of an incident viewed by said video camera,
a portable wireless microphone adapted to be worn by an operator of said law enforcement vehicle and having an ultrasonic receiver, a microphone component and a radio transmitter, said radio transmitter generating a radio signal in response to audio communications received by said microphone component,
a radio receiver responsive to said radio signal for generating audio signals,
an audio/video recorder having means for recording said video signals and said audio signals, and
an ultrasonic transmitter for generating an ultrasonic signal in response to receiving an actuation signal from said audio/video recorder,
said ultrasonic receiver responsive to said ultrasonic signal for activating said radio transmitter.

9. The wireless microphone system as claimed in claim 8 wherein said microphone component receives said ultrasonic signal.

10. The wireless microphone system as claimed in claim 8 wherein said ultrasonic signal is encoded by said ultrasonic transmitter and decoded by said ultrasonic receiver.

11. The wireless microphone system as claimed in claim 8 wherein said ultrasonic transmitter generates said ultrasonic signal for a predetermined period of time.

12. The wireless microphone system as claimed in claim 11 wherein said ultrasonic transmitter repeats said generation of said ultrasonic signal a predetermined number of times.

13. The wireless microphone system as claimed in claim 8 wherein said radio signal is encoded by said radio transmitter and decoded by said radio receiver.

14. The wireless microphone system as claimed in claim 8 further comprising a reset switch to deactivate said radio transmitter.

15. A method of automatically activating a wireless microphone system to input audio information to a surveillance system for a law enforcement vehicle, wherein said surveillance system includes a video camera and an audio/video recorder, said method comprising the steps of:
generating an ultrasonic signal in response to receiving an activation signal from said surveillance system,
receiving said ultrasonic signal at said wireless microphone system,
activating a radio transmitter in the wireless microphone system in response to receiving said ultrasonic signal, and
transmitting a signal from said transmitter to said audio/video recorder having audio information thereon to be recorded.

16. The method as claimed in claim 15 wherein said step of generating an ultrasonic signal includes generating an encoded ultrasonic signal, and said step of receiving said ultrasonic signal includes decoding said encoded ultrasonic signal.

17. The method as claimed in claim 15 wherein said step of generating a radio carrier signal includes encoding said radio carrier signal, and said step of receiving said radio carrier signal includes decoding said encoded radio carrier signal.
